(19) United States
(12) Patent Application Publication
(10) Pub. No.: US 2004/0179229 A1
(43) Pub. Date: Sep. 16, 2004

(54) Printer driver translator apparatus and method

(76) Inventor: John David Laughlin, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/388,861

(22) Filed: Mar. 14, 2003

(51) Int. Cl. G06F 17/28; G06F 3/12; G10L 21/00

(52) U.S. Cl. 358/1.15; 704/2; 704/277

(57) ABSTRACT

A printer driver translator apparatus includes, in a printer system connected to a network, a printer driver on a computer preconfigured with a user interface conformed to provide selection options for language translations to a user. A webserver is provided on a connected printer such that the webserver receives the print job and language selection from the computer and automatically selects an associated language site locator in response to the language translation selection by a user. The webserver is connected with the network and sends the print job to the selected language translation site on the network, in accordance with the selected language translation site locator, for translation. The webserver is further configured to receive a translation of the print job from the selected language translation site for printing by the printer.

### FIELD OF THE INVENTION

This invention relates to a printer driver translator apparatus and method. In particular, according to one embodiment the invention relates to a printer driver translator apparatus and method in a printer system wherein a printer driver on a computer is preconfigured to provide a user interface for the selection of language translation options with at least one language site locator for directing a print job to at least one language translation site on the network prior to printing.

### BACKGROUND OF THE INVENTION

The advent of sophisticated electronic office equipment has greatly enhanced the efficiency and capabilities of workplaces. In particular, a series or system of networked printers greatly enhances the productivity of users in many instances. Nonetheless, certain necessary functions continue to cause delay and, therefore, add expense in commonly recurring situations.

It is often necessary for a print job to be translated from one language to another language. Also, it is often necessary for a print job to be translated from one language to several different languages. Currently, when a user wishes to translate a print job from one language to another, it is typically necessary to send the print job via a network to a remote translation service. This translation service may be located on an intranet or on the Internet. The user is required to identify the language translation site by means of a site locator device. On the Internet, these language translation sites, as are all other sites, are identified by means of a uniform resource locator (URL). A URL is a standard way of specifying the location of an object, typically a web page, on the Internet. URLs are the form of the address used on the World Wide Web. They are used in HTML documents to specify the target of a hyperlink which is often another HTML document (possibly stored on another computer).

In any event, whenever an appropriate site locator can be found by a user, the process currently requires the user to correctly capture it and manually utilize it in conjunction with the printer system to send the subject print job over the network to the identified language translation site. Once the translation is completed, the user must, typically, take additional steps to ensure that the translated print job is printed at the desired location.

### SUMMARY OF THE INVENTION

According to one embodiment, the printer driver translator apparatus of the present invention includes a computer connected to a printer. A printer driver on the computer is conformed to provide a user interface for the selection of language translation options. The user interface includes language translation dictionaries and associated instructions for translation of a print job from one language to another language. The printer driver is further conformed to translate a print job automatically upon the selection by a user of a language into which the print job is to be translated and to send the translated print job to the printer through the network for printing.

### DESCRIPTION OF THE DRAWINGS

FIG. 1 is a schematic diagram of the printer driver translator apparatus according to an embodiment of the present invention;

FIG. 2 is a schematic diagram according to another embodiment of the invention of FIG. 1;

FIG. 3 is a schematic diagram according to another embodiment of the invention of FIG. 1;

FIG. 4 is a schematic diagram according to another embodiment of the invention of FIG. 1; and

FIG. 5 is a schematic diagram according to another embodiment of the invention of FIG. 1 showing multiple remote printers and multiple remote language translation sites connected to the network.

### DETAILED DESCRIPTION OF THE INVENTION

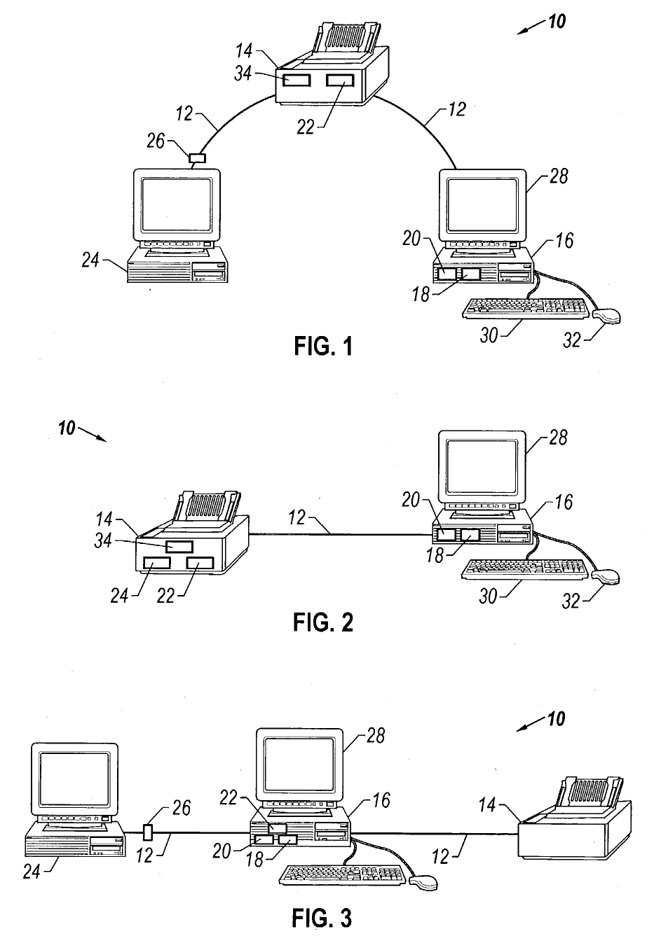

An embodiment of the present invention is illustrated by way of example in FIGS. 1-5. With specific reference to FIG. 1, the printer driver translator apparatus 10 according to an embodiment of the present invention includes a network 12, a printer 14, and a user's computer 16 connected to the network 12. A printer driver 18 on the computer 16 is preconfigured with a user interface 20. The user interface 20 offers a table of language translation options to a user. According to one embodiment, the table of user interface 20 includes a listing of languages from which a translation is to be made and a list of languages into which a translation is to be made.

Printer 14 includes a webserver 22. Webserver 22 includes a table of at least one language translation site(s) 24 and associated language translation site locator(s) 26. Upon receipt of a print job and language translation selection from the printer driver 18, the webserver 22 directs a print job (not shown) to at least one language translation site 24 on the network 12 according to the associated language translation site locator 26 for translation prior to printing. Once translated, webserver 22 receives the translation of the print job from the language translation site 24, formats it for printing and sends the translated print job to the printer 14 for printing.

Printer driver 18 is any device driver now known or hereafter developed conformed to accomplish the purposes of the invention. As is known in the art, device drivers consist of software created to control a hardware component or a peripheral device of a computer such as a magnetic disk, magnetic tape or printer. Printer driver 18 is typically located on computer 16 but may be located on a device remote from computer 16 as is convenient or desired. Computer 16 is any known or hereafter developed computer device for manipulating data and includes monitor 28, keyboard 30 and mouse 32, all as known in the art.

User interface 20 may be any interface now known or hereafter developed. As illustrated in FIG. 1, user interface 20 is shown on computer processing unit 16. User interface 20, for example, is manipulated by means of keyboard 30 and mouse 32 in order to select the appropriate language translation. Again, by way of example and not by limitation, printer driver 18 is conformed to provide user interface 20 to a user for the selection of a desired translation language. A user, for example, can simply scroll through a table of language translations available with mouse 32. The table may be in any form but will include a list of languages from which the print job is to be translated and a list of languages into which the print job is to be translated. These lists may be coordinated in any manner such that the desired language translation selection is captured when the user makes a selection. According to one embodiment, user interface 20 is a graphical user interface such that data may be presented to, and interacted with by the user audibly, visually, or in any manner that it may be otherwise perceived.

According to one embodiment, webserver 22 is preconfigured to include a table of language translation sites 24 and corresponding “associated” language translation site locators 26. Upon receipt of a print job and language translation selection from printer driver 18, webserver 22 automatically associates the print job with a language translation site 24 in accordance with the language translation selected and sends the print job to be translated by the appropriate language translation site 24 by means of language translation site locator 26.

According to another embodiment of the invention, printer 14 includes a user interface 34 for editing the webserver 22 table of language translation sites 24. Any editing tasks desired may be accomplished at the printer 14 by means of user interface 34. For example only, and not by limitation, a user of printer 14 may access user interface 34 to enter new language translation sites, change language translation site locators, and the like.

According to one embodiment, as will be discussed more fully with reference to FIG. 5, printer driver 18 is conformed to direct the translation of a print job to another printer 14 altogether or to many different printers 14′ connected to the network 12. While typically the print job will be printed at the printer 14 to which the print job was originally directed, obvious circumstances exist wherein remote printing of the translation at multiple printers 14′ is desirable and/or required.

Referring now to FIG. 2, printer driver translator apparatus 10 is illustrated in accordance with another embodiment. As described above, computer 16 includes a printer driver 18 configured to present a user interface 20 to a user for the selection of a desired language translation for a print job. Printer driver 18 sends the print job and the language translation selection to webserver 22 on printer 14 via network 12. In this case, however, webserver 22 also contains a language translation site 24 on printer 14. That is, webserver 22 includes the dictionaries and code necessary to accomplish the selected language translation without resort to a remote language translation site 24. According to this embodiment, user interface 34 provides for downloading new dictionaries from the network 12 for new languages, editing existing dictionaries, and updating translation instructions, for example only.

FIG. 3 is an illustration according to another embodiment of the invention. As shown, printer driver 18 and user interface 20 are provided as before on computer 16. Here, however, webserver 22 also resides on computer 16 such that user interface 20 allows selection of a desired language into which to translate the print job and his information is directed internally to webserver 22. Webserver 22 functions as previously described to select the proper language translation site 24 and associated language translation site locator 26. Webserver 22 then forwards the print job to the appropriate language translation site 24 and receives the translation back from the language translation site 24. At this point, webserver 22 sends the translated print job to printer 14 via network 12 for printing. Printer 14 according to this embodiment is just a standard, dumb, printer with no knowledge of or participation in the translation process.

In accordance with this embodiment, webserver 22 does not need to be a full webserver, but may just be a component of the printer driver 18 which has web browser functionality, as is known in the art. In that case all the “webserver” 22 needs to do is make http requests of remote translation services, as web browsers normally do.

Further, user interface 20 includes the capabilities of user interface 34. That is user interface 20 according to this embodiment also enables a user to edit selected language translation data, download new languages from network 12, revise site locators 26, and the like.

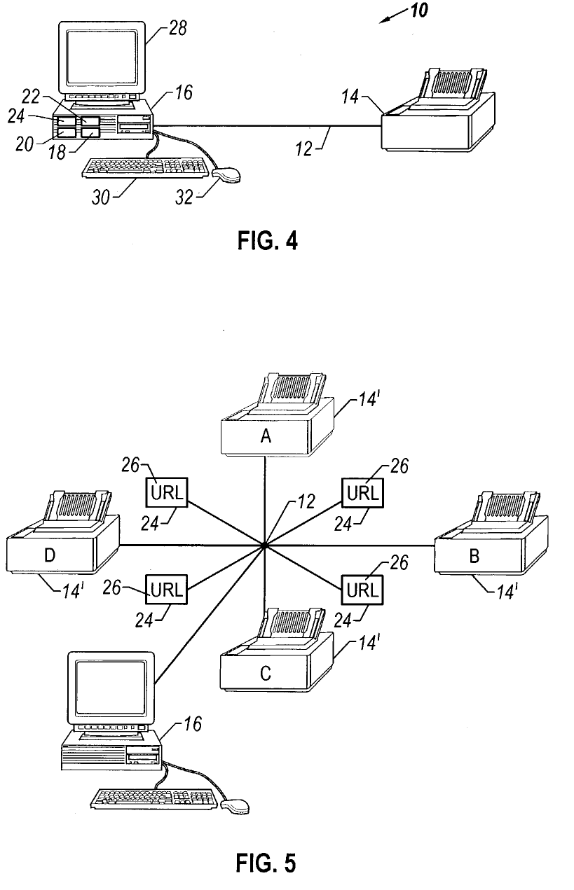

FIG. 4 is an illustration according to another embodiment of the invention. Printer 14 is a dumb printer as in the previous embodiment. Computer 16, on the other hand, is fully independent. That is, according to this embodiment, computer 16 includes all the elements necessary to accomplish a language translation of a print job prior to sending the print job to printer 14. These elements include printer driver 18, user interface 20 and webserver 22. Here, webserver 22 includes an internal language translation site 24 with the dictionaries and instructions necessary to accomplish a selected language translation without sending the print job to an external language translation site 24. In operation, a user accesses user interface 20 and selects a language into which a print job is to be translated. This selection is sent to the webserver 22 internally which translates the print job into the selected language. Webserver 22 then sends the translated print job to printer 14. In this embodiment, there is no need for a fully functional webserver. That is, here the printer driver 18 itself contains a translation component which has all the functionality described in the web services of the other embodiments. In this embodiment, there is no need for URL's or any form of web communication.

User interface 20 includes the capabilities of user interface 34 in this embodiment. That is, again, here user interface 20 not only enables a user to select a translation language, but also allows a user to update language translation data in all the ways previously discussed and in any desired manner.

Referring now to FIG. 5, printer driver translator apparatus 10 of the present invention is illustrated according to a further embodiment. In this embodiment, network 12 is represented by the point at the center of the figure. The figure illustrates multiple printers 14′, A, B, C and D, connected to network 12. In the case of an Intranet, network 12 may have multiple printers 14‘located throughout a company’s building for example. In the case of the Internet, network 12 may connect printers 14′, in remote countries. In that case, for example, a Spanish translation of an English document created on computer 16 that originated in the United States can be translated by means of the printer driver translation apparatus 10 of the present invention and sent to printer 14′ “A” in Spain.

Additionally, language translation sites 24 may be located upon a company Intranet or anywhere on the Internet. Language translation site locators 26, for example, multiple URLs are used to identify the separate language translation sites 24 available. As is known in the art, these URLs may be added to or deleted from as the need occurs.

By way of further explanation, according to an embodiment of the invention, a user of printer driver translator apparatus 10 selects, or assembles, a printer driver 16 preconfigured with a user interface 20 conformed to provide selections to a user for language translations of a print job to be sent to a printer 14 on the network 12. A network server, webserver 22, on printer 14 is conformed to receive the print job from the printer driver 18 with the language selection. Webserver 22 sends the print job to a language translation site 24 in accordance with the user's language selection. The webserver 22 tracks the location of language translation sites on network 12 by means of a language translation site locator 26, such as a URL. Thereafter, the translation is received back by the webserver 22, formatted and printed by the printer 14.

According to other preferred embodiments, the network 12 is the Internet and there are multiple language site locators 26 for directing print jobs to multiple language translation sites 24 through the network connection 12.

The description of the present embodiments of the invention have been presented for the purposes of illustration, but are not intended to be exhaustive or to limit the invention to the form disclosed. Many modifications and variations will be apparent to those of ordinary skill in the art. As such, while the present invention has been disclosed in connection an embodiment thereof, it should be understood that there may be other embodiments which fall within the spirit and scope of the invention as defined by the following claims.

What is claimed is:

1. A printer driver translator apparatus comprising:
a) a computer connected to a printer; and
b) a printer driver on the computer conformed to provide a user interface for the selection of language translation options wherein the user interface also includes language translation dictionaries and associated instructions for translation of a print job from one language to another language;
c) wherein the printer driver is further conformed to translate a print job automatically upon the selection by a user of a language into which the print job is to be translated and to send the translated print job to the printer by the network for printing.

2. A printer driver translator apparatus comprising:
a) a printer and a computer connected via a network;
b) a printer driver on the computer, the printer driver configured to provide a user with a user interface for the selection of a language into which a print job is to be translated prior to sending the print job to the printer;
c) wherein the printer driver includes a table of language translation sites and associated language translation site locators such that when a user selects a language into which a print job is to be translated, the printer driver sends the print job to the language translation site in accordance with the associated language translation site locator; and
d) wherein upon receipt of a translated print job from the language translation site, the printer driver sends the translated print job to the printer via the network for printing.

3. A printer driver translator apparatus comprising:
a) a printer and a computer connected to each other via a network;
b) a printer driver on the computer configured to provide a user with a user interface for the selection of a language into which a print job is to be translated prior to printing;
c) a network server on the printer configured to contain a table of language translation dictionaries and translation instructions for the translation of a print job received from the printer driver into the selected language; and
d) a printer user interface configured to connect to the network and enable a user to download new language translation dictionaries, to edit existing language translation dictionaries and to update translation instructions.

4. In a printer system connected to a network, a printer driver translator apparatus, the apparatus comprising:
a) a printer driver on a computer preconfigured to provide a user interface for the selection of at least one translation language and for directing a print job to a printer connected to said network prior to printing; and
b) a webserver on said printer configured with a table of language translation sites and conformed to connect said printer with said network and to send said print job to a language translation site on said network, in accordance with the selected at least one translation language, for translation and to receive a translation of said print job from said language translation site for printing by said printer.

5. The apparatus of claim 4 wherein the printer driver user interface includes a list of languages to be translated from and languages to be translated to.

6. The apparatus of claim 4 wherein the webserver table of language translation sites includes a list of languages to be translated from and languages to be translated to and associated language translation site locators.

7. The apparatus of claim 4 wherein the webserver further includes a user interface for editing the table of language translation sites.

8. The apparatus of claim 4 wherein the network is the Internet.

9. The apparatus of claim 6 wherein the associated language site locator is a URL.

10. The apparatus of claim 4 wherein the printer driver user interface is a graphical user interface.

11. The apparatus of claim 7 wherein the webserver user interface is a graphical user interface.

12. The apparatus of claim 4 wherein the printer driver is further conformed to direct the translation of a print job to more than one printer connected to the network.

13. In a printer system of at least one user computer and at least one printer connected to each other by the Internet, a printer driver translator apparatus, the apparatus comprising:
a) a printer driver means on a user's computer preconfigured with a user interface means for selection of language translation options and for sending a language translation selection to a printer along with a print job;
b) a webserver means on the printer preconfigured with a table of language translation sites and associated language translation site URLs conformed to receive language selections and print jobs from the printer driver means and to send the print job to a selected language translation site on the Internet, in accordance with the associated language translation site URL, for translation and to receive a translation from the selected language translation site of the print job for printing by the printer; and
c) a user interface means on the printer conformed to allow editing of the table of language translation sites and associated language translation site URLs.

14. The apparatus of claim 13 wherein the user interface means are graphical user interfaces.

15. In a printer system, a program product for providing a printer driver translator, the program product comprising:
a) instructions for a printer driver configured to provide for the selection of at least one language translation;
b) instructions for a user interface configured to provide selection options for language translations to a user and to automatically select an associated language translation site locator in response to a language translation selection by a user; and
c) instructions for a webserver configured to connect with a network and to send a print job to a selected language translation site on the network, in accordance with the associated language translation site locator, for translation and to receive a translation from the selected language translation site of the print job for printing by a printer.

16. The program code of claim 15 wherein the instructions for a user interface include instructions for a graphical user interface.

17. The program code of claim 15 wherein the instructions for a user interface include instructions for a table of languages to be translated from and languages to be translated to and the language site locator instructions include instructions for associated URLs.

18. The program code of claim 15 wherein the instructions for a user interface include instructions for editing the language translation selection options.

19. In a printer system connected to a network, a printer driver translation method, the method comprising the steps of:
a) preconfiguring a printer driver on a user's computer with a user interface;
b) conforming the user interface to provide selection options for language translations for a print job to be sent to a printer on the network;
c) providing a webserver on a printer connected to the network and conforming the webserver to automatically select an associated language translation site locator in response to the language translation selection by a user and to connect with the network and to send a print job to a selected language translation site on the network, in accordance with the associated language translation site locator, for translation and to receive a translation of the print job from the selected language translation site for printing by the printer; and
d) submitting a print job to the printer driver, selecting a specific language translation and sending the print job and language translation selection to the printer webserver.

20. The method of claim 19 wherein the printer system is connected to the Internet.

21. The method of claim 19 wherein the printer system is connected to the Internet and wherein step c) includes the step of conforming the webserver to automatically associate a URL with a language translation selection for directing a print job to the associated language translation site on the Internet.

22. The method of claim 19 wherein step a) comprises the step of providing a graphical user interface.

23. The method of claim 19 further comprising the step of conforming the printer driver to direct the translation of a print job to more than one printer connected to the network.
